(19) United States
(12) Patent Application Publication
(10) Pub. No.: US 2005/0047115 A1
(43) Pub. Date: Mar. 3, 2005

(54) Method for making a lamp string

(76) Inventor: Hsi-Huang Lin, Taipei City (TW)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 10/964,444

(22) Filed: Oct. 12, 2004

Related U.S. Application Data
(63) Continuation-in-part of application No. 10/247,724, filed on Sep. 17, 2002.

(51) Int. Cl. F21V 21/08

(52) U.S. Cl. 362/104; 362/800; 362/806; 362/405; 362/406; 362/327; 362/236; 362/253

(57) ABSTRACT

A method of making a lamp string includes: providing conducting strips each having first and second opposite end portions, and aligning the conducting strips with one another, the first end portion of each of the conducting strips being spaced apart from and succeeding the second end portion of a corresponding one of the conducting strips; electrically connecting light emitting elements to the first end portions, respectively; electrically and respectively connecting metal wires to the light emitting elements and the second end portions; reversing the conducting strips and placing the light emitting elements and the metal wires upside down in cavities, respectively; encapsulating the light emitting elements and the metal wires in the cavities to form semi-encapsulating bodies; reversing the conducting strips and disposing the semi-encapsulating bodies upwardly; and forming a complementary encapsulating body below each of the semi-encapsulating bodies to form an integral encapsulating body.

### CROSS-REFERENCE TO RELATED APPLICATION

This application is a continuation-in-part of pending U.S. patent application Ser. No. 10/247,724, filed on Sep. 17, 2002.

### BACKGROUND OF THE INVENTION

1. Field of the Invention

The invention relates to a method for making a lamp string, more particularly to an automated method for making a lamp string at minimal costs.

2. Description of the Related Art

In a conventional method for making a lamp string, an illuminating device, such as a light bulb or a light emitting diode lamp, is usually connected to a conducting wire unit manually. This is because the conventional light bulb or the light emitting diode lamp is formed with either a base or a pair of terminals adapted to be electrically connected to other devices. Therefore, in view of the structure of the conventional illuminating device, the illuminating devices can only be inserted into lamp sockets on the conducting wire unit manually. Since direct formation of the conventional illuminating devices on the conducting wire unit is not contemplated, in order to form a lamp string using the conventional method, the illuminating devices have to be inserted into the lamp sockets individually and manually, which results in a waste of materials and human resources.

### SUMMARY OF THE INVENTION

Therefore, the object of the present invention is to provide an automated method for making a lamp string, which can be conducted at minimal costs.

The method for making a lamp string according to this invention includes the steps of: (a) providing a plurality of conducting strips each having a first end portion and a second end portion opposite to the first end portion, and aligning the conducting strips with one another, the first end portion of each of the conducting strips being spaced apart from and succeeding the second end portion of a corresponding one of the conducting strips; (b) electrically connecting a plurality of light emitting elements to the first end portions of the conducting strips, respectively; (c) electrically and respectively connecting a plurality of metal wires to the light emitting elements and the second end portions of the conducting strips so that each of the metal wires bridges one of the light emitting elements and a corresponding one of the second end portions of the conducting strips; (d) reversing the conducting strips and placing the light emitting elements and the metal wires upside down in a plurality of cavities, respectively; (e) encapsulating the light emitting elements and the metal wires in the cavities with an insulating material to form a plurality of semi-encapsulating bodies each interconnecting the first end portion of a corresponding one of the conducting strips and the second end portion of another corresponding one of the conducting strips; (f) reversing the conducting strips such that the semi-encapsulating bodies are oriented upwardly; and (g) forming a complementary encapsulating body below each of the semi-encapsulating bodies to form an integral encapsulating body.

### BRIEF DESCRIPTION OF THE DRAWINGS

Other features and advantages of the present invention will become apparent in the following detailed description of the preferred embodiment with reference to the accompanying drawings, of which:

FIGS. 1, 2, 3, 4, 5, and 6 are schematic views showing consecutive steps of the preferred embodiment of a method for making a lamp string according to this invention.

### DETAILED DESCRIPTION OF THE PREFERRED EMBODIMENT

The preferred embodiment of the method for making a lamp string according to this invention includes the steps of:

A) providing a plurality of conducting strips 11:

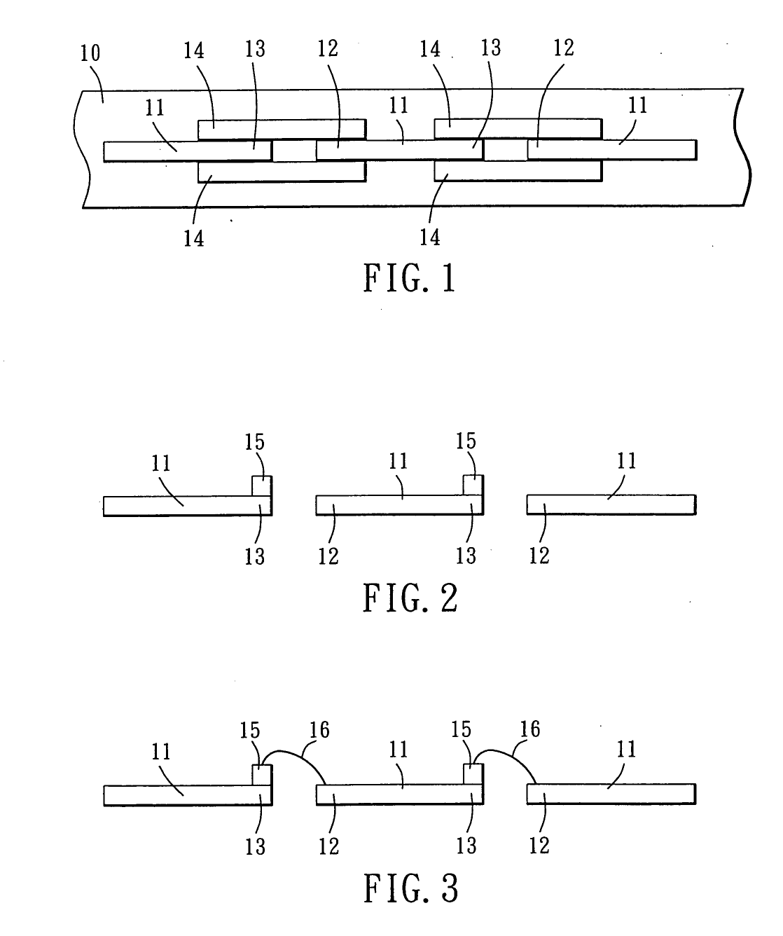

Referring to FIG. 1, the conducting strips 11 are provided on a working table 10, and are positioned by a plurality of grippers 14. Each of the conducting strips 11 has a first end portion 13 and a second end portion 12 opposite to the first end portion 13. The conducting strips 11 are aligned with one another. The first end portion 13 of each of the conducting strips 11 is spaced apart from and succeeds the second end portion 12 of a corresponding one of the conducting strips 11.

B) electrically connecting a plurality of light emitting elements 15:

Referring to FIG. 2, the light emitting elements 15 are electrically connected to the first end portions 13 of the conducting strips 11, respectively, by using a conductive paste. In the preferred embodiment, the light emitting elements 15 are light emitting diodes. Each of the light emitting elements 15 includes a first electrode conductively connected to a top side of the first end portion 13 of a corresponding one of the conducting strips 11 via the conductive paste.

C) electrically connecting a plurality of metal wires 16:

Referring to FIG. 3, the metal wires 16 are electrically and respectively connected to second electrodes of the light emitting elements 15 and the second end portions 12 of the conducting strips 11 by ultrasonic bonding so that each of the metal wires 16 bridges one of the light emitting elements 15 and the second end portion 12 of a corresponding one of the conducting strips 11.

D) reversing the conducting strips 11:

Referring to FIG. 4, the conducting strips 11 are reversed, and the light emitting elements 15 and the metal wires 16 are placed upside down in a plurality of cavities 18, respectively.

E) encapsulating the light emitting elements 15 and the metal wires 16:

The light emitting elements 15 and the metal wires 16 are encapsulated with an insulating material 17 in the cavities 18 to form a plurality of semi-encapsulating bodies. Each of the semi-encapsulating bodies interconnects the first end portion 13 of a corresponding one of the conducting strips 11 and the second end portion 12 of another corresponding one of the conducting strips 11. Preferably, the insulating material 17 is a transparent epoxy resin. The cavities 18 can be filled with the insulating material 17 before or after the step D), and the insulating material 17 is cured after the light emitting elements 15 and the metal wires 16 are encapsulated with the insulating material 17 so as to form the semi-encapsulating bodies.

F) reversing the conducting strips 11:

Referring to FIG. 5, the conducting strips 11 are reversed once again such that the semi-encapsulating bodies are oriented upwardly and face away from the corresponding cavities 18.

G) forming a complementary encapsulating body:

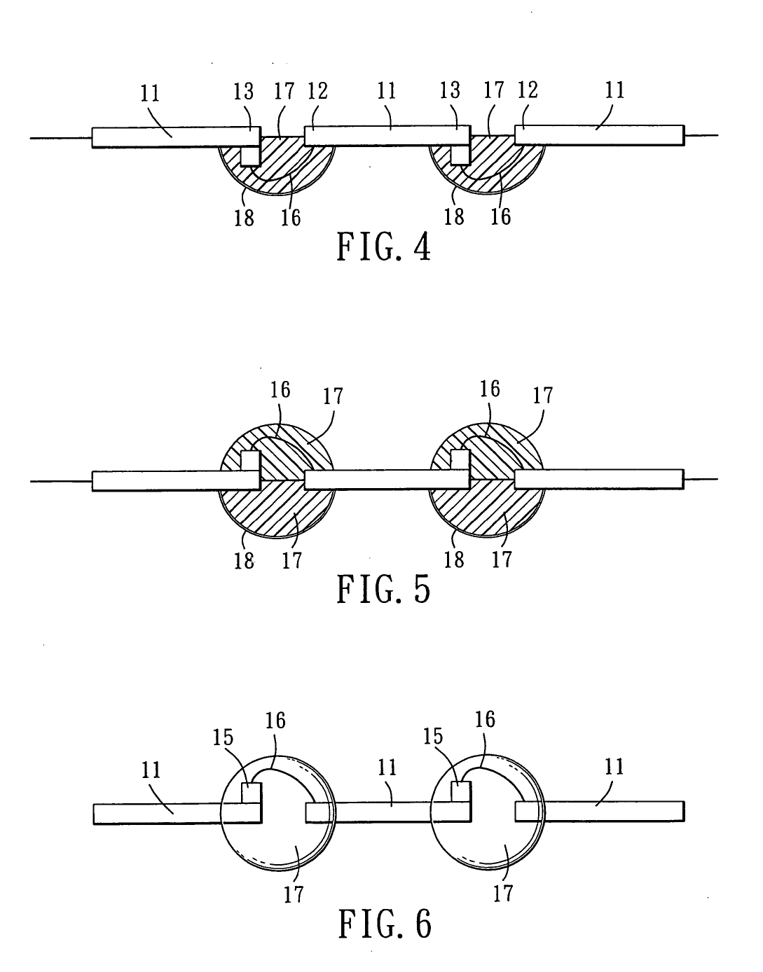

A complementary encapsulating body is formed below each of the semi-encapsulating bodies by filling and curing the insulating material 17 in the cavities 18 so as to form an integral encapsulating body, which is then removed from the corresponding cavity 18, thereby obtaining the lamp string shown in FIG. 6.

In view of the aforesaid, the method of the present invention can be conducted in an automated manner, which not only saves human resources but also increases productivity.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

1. A method for making a lamp string, comprising the steps of:
(a) providing a plurality of conducting strips each having a first end portion and a second end portion opposite to said first end portion, and aligning said conducting strips with one another, said first end portion of each of said conducting strips being spaced apart from and succeeding said second end portion of a corresponding one of said conducting strips;
(b) electrically connecting a plurality of light emitting elements to said first end portions of said conducting strips, respectively;
(c) electrically and respectively connecting a plurality of metal wires to said light emitting elements and said second end portions of said conducting strips so that each of said metal wires bridges one of said light emitting elements and a corresponding one of said second end portions of said conducting strips;
(d) reversing said conducting strips and placing said light emitting elements and said metal wires upside down in a plurality of cavities, respectively;
(e) encapsulating said light emitting elements and said metal wires in said cavities with an insulating material to form a plurality of semi-encapsulating bodies each interconnecting said first end portion of a corresponding one of said conducting strips and said second end portion of another corresponding one of said conducting strips;
(f) reversing said conducting strips such that said semi-encapsulating bodies are oriented upwardly; and
(g) forming a complementary encapsulating body below each of said semi-encapsulating bodies to form an integral encapsulating body.

2. The method as claimed in claim 1, wherein each of said light emitting elements includes a first electrode conductively connected to a top side of said first end portion of a corresponding one of said conducting strips, said metal wires electrically and respectively connecting second electrodes of said light emitting elements to said second end portions of said conducting strips.

3. The method as claimed in claim 2, wherein each of said light emitting elements is a light emitting diode.

4. The method as claimed in claim 1, wherein said insulating material is transparent.
